(19) United States
(12) Patent Application Publication
(10) Pub. No.: US 2007/0194185 A1
(43) Pub. Date: Aug. 23, 2007

(54) Vehicle top carriers

(76) Inventors: Jason Carothers, Portland, OR (US); Jeff Castro, Portland, OR (US); Dominic D'Andrea, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/606,638

(22) Filed: Nov. 29, 2006

Related U.S. Application Data
(60) Provisional application No. 60/740,705, filed on Nov. 29, 2005.

(51) Int. Cl. F16M 11/00; F16M 13/00

(52) U.S. Cl. 248/200; 248/518

(57) ABSTRACT

A cargo carrier is configured to be mounted on a vehicle roof. A lid is pivotally attached to a bottom portion forming an easily accessible enclosure for carrying and protecting cargo. The lid may be reinforced to provide desired stiffness and sturdiness characteristics.

### CROSS-REFERENCE TO RELATED APPLICATIONS

This application is based upon and claims priority under 35 U.S.C. § 119 from U.S. Provisional Patent Application Ser. No. 60/740,705 filed Nov. 29, 2005, which is incorporated herein by reference in its entirety for all purposes.

This application incorporates by reference in their entirety for all purposes the following U.S. Pat. No. 6,905,053, issued Jun. 14, 2005; and No. 6,918,521, issued Jul. 19, 2005. This application also incorporates by reference in their entirety for all purposes the following U.S. patent applications: Ser. No. 10/767,398, filed Jan. 28, 2004; Ser. No. 11/152,674, filed Jun. 13, 2005; and Ser. No. 60/729,503, filed Oct. 21, 2005.

### FIELD OF THE INVENTION

The invention relates to assemblies for carrying cargo items on a vehicle. In particular, the invention provides improvements for cargo boxes or cargo trunks designed for mounting on a roof of a vehicle.

### BACKGROUND

Vehicle top carriers, such as cargo boxes or cargo trunks, have become quite popular in recent years. Enclosed carriers may be preferable over conventional open racks for a variety of reasons. For example, enclosed carriers protect cargo items from the elements such as wind, rain, and snow. Additionally, enclosed carriers may be more secure from theft or vandalism.

Some vehicle top carriers, however, have problems associated with their use and/or storage. For example, some plastic, semi-rigid cargo carriers include flexible tops or lids which may not be sufficiently stiff when a user manipulates the lid between open and closed positions. Consequently, the lid manifests inconsistent and/or “floppy” motions when a user opens and closes the carrier.

### SUMMARY

A box configured for mounting on top of a vehicle includes a reinforced lid pivotally attached to a bottom portion, forming an easily accessible enclosure for carrying cargo.

### BRIEF DESCRIPTION OF THE DRAWINGS

FIG. 1 is a side view of a cargo carrier mounted on top of a vehicle

FIG. 2 is a partially cut away perspective view of a cargo box lid.

FIG. 3 is a perspective view of a stiffening member configured for reinforcing the lid of a cargo box.

FIG. 4 is a cross-sectional view through the lid and reinforcing structure illustrated in FIG. 1.

FIGS. 5 and 6 illustrate alternative lid reinforcing structures.

FIGS. 7 and 8 illustrate net devices used to secure cargo items on the inner side of cargo box lid.

### DETAILED DESCRIPTION

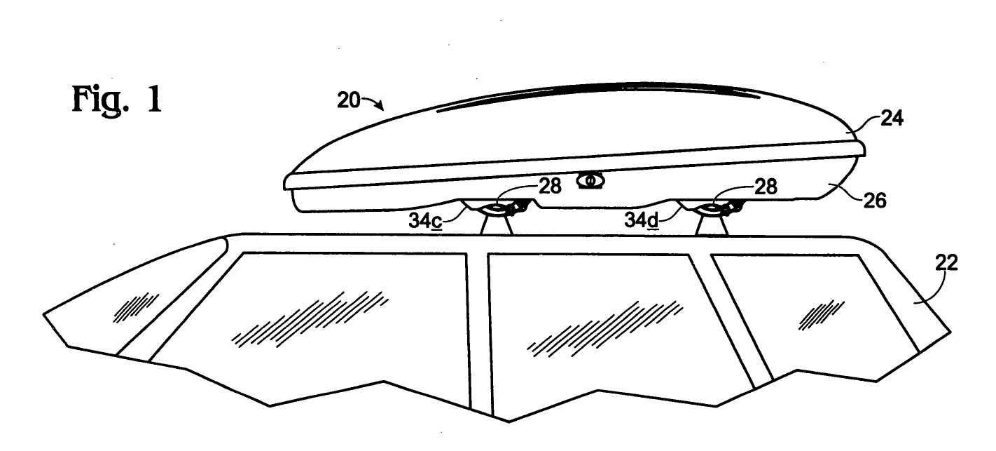

FIG. 1 shows a vehicle top carrier 20 mounted on crossbars 22 of roof rack 24 on vehicle 26. The long axis of vehicle top carrier 20 is perpendicular to crossbars 22. Vehicle top carrier or box 20 includes top or lid 28 connected via hinges (not shown) to bottom portion 30, including floor 32. Four clamps 34 (only two are shown) secure vehicle top carrier 20 to crossbars 22. Latch 36 keeps vehicle top carrier 20 closed, and may be operated to allow opening when desired. Latch 36 may be provided with a key device, combination operated device, and/or any suitable lock mechanism. Box 20 may have sets of hinges on one, two or more sides permitting opening of the box on one, two or more sides. Hinges for box 20 may be dual functioning alternately as a hinge or a latch. In a preferred design, each lateral side of the box is equipped with a set of latch/hinges so that the box may be opened from either side of the box.

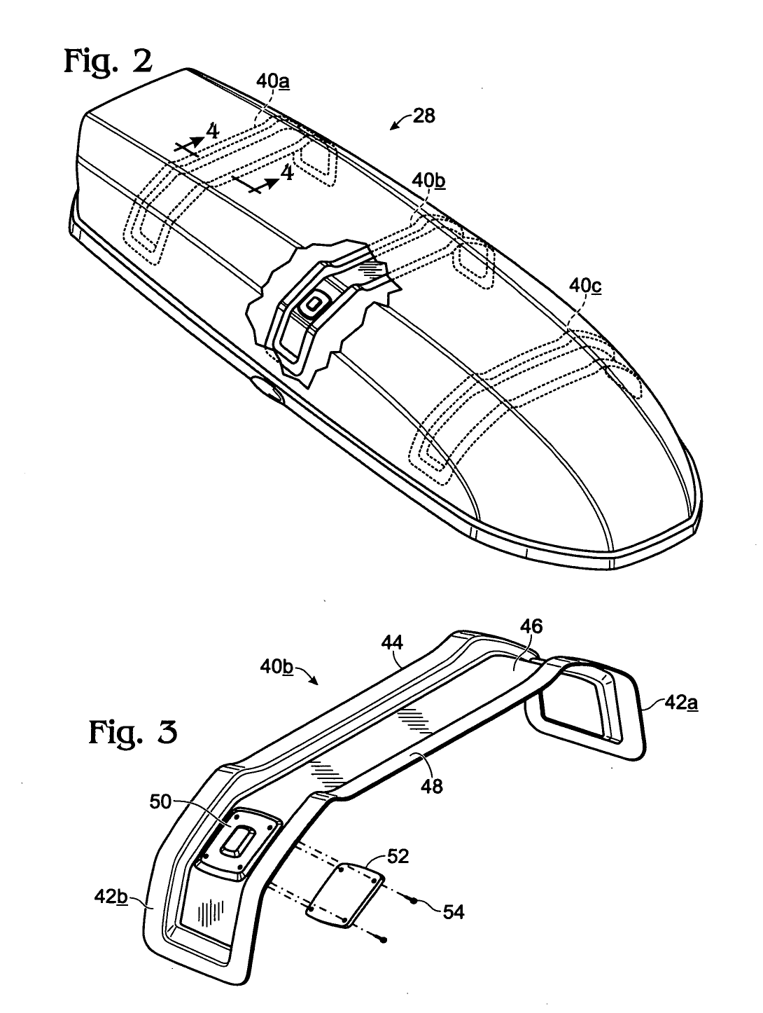

FIG. 2 shows an example of a preferred lid stiffening assembly. Lid 28 has three transverse stiffening members 40a, 40b and 40c bonded to a an interior surface of lid 28.

FIG. 3 shows an isolated perspective view of lid stiffening member 40b. Stiffening member 40b includes leg portions 42a and 42b connected to center beam portion 44. Internal recess 46 spans from leg portion 42a through center beam portion 44 to leg portion 42b. Flange 48 forms a continuous boundary around recess 46, providing a parametric surface for bonding to the internal surface of lid 28. As shown in FIG. 3, stiffening member 40b has a pre-formed semi-rigid shape substantially conforming to the shape of the inner surface of lid 28. In a preferred lid configuration, adhesive is used to bond flange 48 to the inner surface of lid 28. Any appropriate adhesive may be used along with appropriate clamping or curing techniques, as are well known in the art. Recess 46 also includes one or more, preferably two, cavities 50 for mounting accessories such as light device 52 by screws 54.

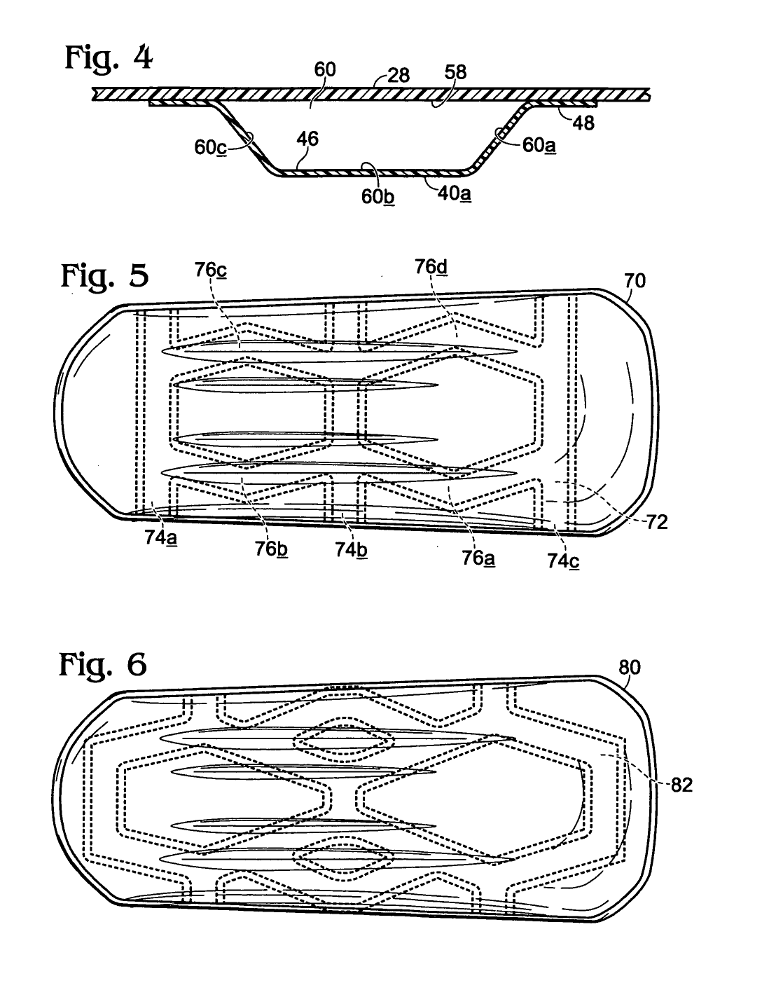

FIG. 4 shows a cross section through lid 28 and stiffening member 40a. Flange 48 is bonded to inner surface 58 of lid 28. Recess 46 creates angled walls 60a, 60b and 60c spaced away from inner surface 58 of lid 28 which creates a stiffening, torsion stabilizing effect on lid 28. In a lid such as the one shown in FIG. 2, having a long axis, and being hinged at multiple points with respect to a bottom portion of the box, one or more, preferably three, substantially parallel, transverse stiffening members provide desirable stiffening benefits to the cargo box lid.

FIGS. 5 and 6 show alternative stiffening member configurations. In FIG. 5, lid 70 has a single, more extensive stiffening member 72 including three transverse components 74a-c, connected by angular cross components 76a-d. FIG. 6 shows lid 80 including another stiffening member configuration 82. Many different levels and/or orientations of stiffening, or torsion stability, may be achieved by using different stiffening member configurations. Selection of an appropriate stiffening member configuration may involve consideration of lid material composition, geometry, points of attachment to the bottom, functional goals relative to lid opening and closing, coordination with internal accessories or cargo items inside the box, etc.

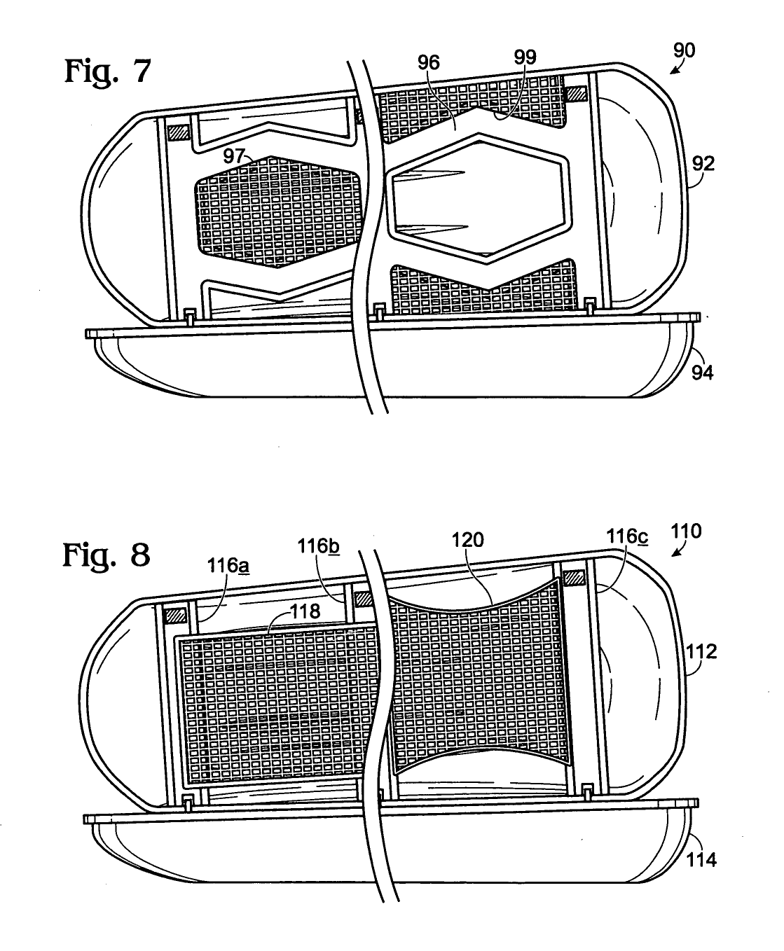

FIGS. 7 and 8 show alternative embodiments in which cargo nets are integrated with stiffening members, providing various compartments for carrying selected cargo items. In FIG. 7, box 90 includes lid 92, hinged at three locations to bottom portion 94. Stiffening member 96 is bonded to interior surface of lid 92. Nets 97 and 99 are at least partially attached to points along stiffening member 96. The nets may include suitable opening and closing devices (not shown) for carrying selected cargo items. Similarly, FIG. 8 shows box 110 including lid 112 hinged to bottom portion 114. Transverse stiffening members 116a-c are bonded to lid 112. Transverse stiffening members 116a-c are bonded to inner surface of lid 112. Cargo nets 118 and 120 are secured to stiffening members 116a-c to provide compartments for carrying selected cargo items in internal spaces adjacent the surface of lid 112.

In addition to the examples discussed above, lid support structures may provide one or more mounting points for any suitable accessories and/or equipment, such as the accessories and/or equipment described in U.S. Provisional Patent Application Ser. No. 60/729,503 entitled “Vehicle Top Carriers” filed on Oct. 21, 2005, the complete disclosure of that application has been incorporated by reference for all purposes.

Support structures may be mounted to the underside of a lid by any suitable method. Support structures may be mounted by mechanical and/or chemical bonding. Support structures may also be formed as part of the lid.

Lid support structures also may be any suitable shape. For example, support structures may have a generally elongate shape with a rectangular cross-section that conforms to the shape of the underside of a cargo box lid. Support structures may have curvilinear and/or other rectilinear cross-sections and/or surfaces.

Support structures may include one or more content retention structures, which may include any suitable structure configured to retain and/or support cargo items in the lid of the carrier. For example, retention structures may include one or more cargo nets such as the ones described above. The cargo nets may be any suitable size and/or number. A single cargo net may span the support structures, and/or a cargo net may be included for each pair of support structures. Cargo nets also may be made of any suitable material, such as elastic and/or woven material. Cargo nets may be attached to one or more of the support structures via one or more attachment structures such as grooves, hooks, hook and loop devices, etc.

In addition to the examples discussed above, lights may be mounted or incorporated on or between one or more of the support structures. The lights may include any suitable light emitting structures, such as incandescent and/or light emitting diodes (LEDs). The lights may be powered via any suitable means, such as one or more batteries and/or one or more solar panels. Illumination device switches may be operated manually, such as by user manipulation, and/or automatically, such as when the lid is raised and/or lowered. Illumination devices may be configured to be removable from the lid to allow a user to use those devices for illuminating other areas remote from the box. Illumination devices may be snap-in flashlights and/or stock flashlights held within the underside of the lid via one or more holders.

Although vehicle top carriers and features of vehicle top carriers have been shown and described with reference to the foregoing operational principles and preferred embodiments, those skilled in the art will recognize that various changes in form and detail may be made without departing from the spirit and scope of the claims. The present disclosure is intended to embrace all such alternatives, modifications, and variations.

We claim:

1. A stiffening structure for strengthening a lid on a carrier configured for carrying cargo on top of a vehicle comprising
semi-rigid support member having a central portion connected to first and second leg portions, one or more border flanges substantially bounding the support member for bonding to an interior surface of the lid, an internal recessed portion spanning from the first leg portion through the central portion to the second leg portion, wherein the support member has a pre-formed shape conforming to an interior surface of the lid.

2. The stiffening structure of claim 1, wherein the pre-formed shape includes bends conforming to corner portions of the lid.

3. The stiffening structure of claim 1, wherein the pre-formed shape includes multiple non-parallel planes.

4. The stiffening structure of claim 1, wherein the border flange forms a continuous boundary around the support member.

5. The stiffening structure of claim 1, wherein the recessed portion has a bottom side oriented for facing the internal space of the carrier, the bottom side having one or more nesting structures for mounting a light device.

6. The stiffening structure of claim 5, further comprising
a light device mounted in the nesting structure.

7. The stiffening structure of claim 1, wherein the pre-formed shape of the stiffening structure is shaped for mounting transversely inside the lid of the carrier.

8. The stiffening structure of claim 1, wherein the stiffening structure has a substantially constant width.

9. A lid stiffening system comprising
three stiffening structures as recited in claim 1, configured for parallel transverse mounting inside the lid.

10. A box for carrying cargo on top of a vehicle comprising
a bottom portion
a lid portion hinged to the bottom portion, the lid portion having an internal surface,
one or more semi-rigid support members bonded to the internal surface of the lid portion, the support member having an internal recessed portion substantially bounded by one or more border flanges bonded to the internal surface of the lid portion.

11. The box of claim 10, wherein the support member has a pre-formed shape conforming to an interior surface of the lid.

12. The box of claim 10, wherein border flange forms a continuous boundary around the support member.

13. The box of claim 10, wherein the lid portion has at least three transverse parallel support members bonded to the internal side of the lid portion.

14. The box of claim 10, wherein the recessed portion has a bottom side oriented for facing the internal space of the carrier, the bottom side having one or more nesting structures for mounting a light device.

15. The box of claim 10, wherein the lid portion is equipped for optional opening on two opposite sides of the box.

16. The box of claim 10, further comprising
one or more cargo nets connected to the support member.
